(19) United States
(12) Patent Application Publication
(10) Pub. No.: US 2026/0212631 A1
(43) Pub. Date: Jul. 23, 2026

(54) SYSTEMS, APPARATUSES, METHODS, AND NON-TRANSITORY COMPUTER-READABLE STORAGE MEDIA FOR MULTIMODAL INTERACTION USING PEN-BASED GESTURE

(71) Applicant: HUAWEI TECHNOLOGIES CO., LTD., Shenzhen (CA)

(72) Inventors: Yu ZHAO, Richmond Hill (CA); ABBY Lui, Scarborough (CA); Soumil Chugh, Markham (CA); Che Yan, Scarborough (CA); Yuan Deng, Markham (CA)

(21) Appl. No.: 19/032,607

(22) Filed: Jan. 21, 2025

(51) Int. Cl. G06V 10/26; G06V 10/22; G06V 10/74

(52) U.S. Cl. CPC G06V 10/26; G06V 10/235; G06V 10/761

(57) ABSTRACT

A computerized method for processing an image, the method has the steps of: identifying a plurality of objects of a plurality of granularity levels from the image, and processing the image based on the identified plurality of objects; wherein said identifying the plurality of objects has the steps of: in a first iteration, using an artificial intelligence (AI) engine to segment the image and identify from the segmented image one or more objects of a first granularity level among the plurality of objects, and in each of one or more subsequent iterations, using the AI engine to segment each object identified in a previous iteration and identify from the segmented object one or more objects of a next granularity level among the plurality of objects.

### FIELD OF THE DISCLOSURE

The present disclosure relates generally to systems, apparatuses, methods, and computer-readable storage media for multimodal interaction, and in particular to systems, apparatuses, methods, and computer-readable storage media for multimodal interaction using pen-based gesture.

### BACKGROUND

With the fast development of artificial intelligence (AI) generated content in recent years leads to the arising of features related to region-based image editing. Unlike free-form editing, region-based image editing may involve the imaging processing only based on a source image and an instruction (for example, removing people in the background). In region-based image editing, selecting semantic regions as guidance along with stating an instruction significantly boasts editing accuracy.

However, existing region-based image editing solutions for touch devices do not allow for different levels of granularity and multi-selection. Action recommendations are not generated proactively depending on the selected region, and in some cases, there is no preview of what the user is selecting prior to the selection gesture, leading to a repetitive and time-consuming editing workflow.

### SUMMARY

According to one aspect of this disclosure, there is provided a computerized method computerized method for processing an image, the method comprising: identifying a plurality of objects of a plurality of granularity levels from the image; and processing the image based on the identified plurality of objects; wherein said identifying the plurality of objects comprises: in a first iteration, using an artificial intelligence (AI) engine to segment the image and identify from the segmented image one or more objects of a first granularity level among the plurality of objects, and in each of one or more subsequent iterations, using the AI engine to segment each object identified in a previous iteration and identify from the segmented object one or more objects of a next granularity level among the plurality of objects.

In some embodiments, said processing the image based on the identified plurality of objects comprises: receiving a first input indicating an area of the image; determining, from the plurality of objects, a plurality of overlapping objects that overlap with the area indicated by the first input; assessing one or more features to determine a user-intended granularity level from the granularity levels of the plurality of overlapping objects; and determining one of the plurality of overlapping objects as a selected object.

In some embodiments, the first input indicates a pointer contacting the area of the image.

In some embodiments, the one or more features comprise: an image zooming setting; a precision of the first input; a position of the first input; a history of previous object selection; a list of already selected objects; or a combination thereof.

In some embodiments, said processing the image based on the identified plurality of objects comprises: receiving a second input; and determining, from the plurality of objects, a plurality of overlapping objects that overlap with the second input; assessing one or more features to determine a user-intended granularity level from the granularity levels of the plurality of overlapping objects; determining one of the plurality of overlapping objects as a candidate object; and displaying a preview of the candidate object.

In some embodiments, the second input indicates a pointer hovering over the image.

In some embodiments, said processing the image based on the identified plurality of objects further comprises: receiving a second input indicating the pointer touching the candidate object; and marking the candidate object as a selected object.

In some embodiments, said processing the image based on the identified plurality of objects further comprises: receiving a first input indicating an area of the image; determining, from the plurality of objects, a first selected object overlapping with the area indicated by the first input; receiving a second input; determining a plurality of candidate objects in response to the second input; calculating a similarity between each of the plurality of candidate objects and the first selected object, thereby obtaining a plurality of similarities for the plurality of candidate objects; and marking one or more of the plurality of candidate objects as one or more second selected objects based on similarity comparison of the plurality of similarities and a similarity threshold.

In some embodiments, the first input indicates a pointer contacting the area of the image.

In some embodiments, the second input indicates pointer sliding over the image, or indicates manipulation of an object-selection user interface (UI) component.

In some embodiments, said processing the image based on the identified plurality of objects further comprises: receiving a third input; and adjusting the similarity threshold in response to the third input.

In some embodiments, said processing the image based on the identified plurality of objects further comprises: receiving a third input; deselecting the first and second selected objects; and selecting all other objects in the image or selecting a scene of the image without the first and second selected objects.

In some embodiments, said processing the image based on the identified plurality of objects further comprises: receiving a third input indicating the pointer touching or sliding on one or more of the first and second selected objects; and deselecting the one or more of the first and second selected objects overlapping with the third input.

In some embodiments, said processing the image based on the identified plurality of objects further comprises: receiving a first input; and selecting, based on the first input, one or more of the plurality of candidate objects, one or more regions of the image, or a combination thereof; wherein the first input is an indication of manipulation of an object-selection user interface (UI) component or an indication of a pointer touching on the image.

In some embodiments, when the first input is the indication of the pointer touching on the image, said selecting, based on the first input, the one or more of the plurality of candidate objects, the one or more regions of the image, or the combination thereof comprises:
when the indication of the pointer touching on the image is an indication of the pointer sliding from a first object of the plurality of candidate objects to a second object of the plurality of candidate objects, selecting the first object, and selecting any object along a sliding trace of the pointer having similarities to the first object that is greater than a similarity threshold,
when the indication of the pointer touching on the image is an indication of the pointer sliding from a first object of the plurality of candidate objects to a second object of the plurality of candidate objects, selecting the first object, and selecting any object along a sliding trace of the pointer having a same granularity level as that of the first object and having similarities to the first object that is greater than a similarity threshold,
when the indication of the pointer touching on the image is an indication of the pointer sliding from a selected object of one or more of selected objects of the plurality of candidate objects to a location outside the image, selecting the plurality of objects except the one or more of selected objects or all image components except the one or more of selected objects, and deselecting the one or more of selected objects,
when the indication of the pointer touching on the image is an indication of the pointer touching and holding on a selected object of the plurality of candidate objects, deselecting the selected object,
when the indication of the pointer touching on the image is an indication of the pointer sliding from a first object of the plurality of candidate objects over one or more second objects of the plurality of candidate objects and arriving at a third object of the plurality of candidate objects, selecting the first object, the one or more second objects, and the third object, then when the indication of the pointer touching on the image becomes an indication of the pointer touching and holding on the third object, deselecting the one or more second objects,
when the indication of the pointer touching on the image is an indication of the pointer sliding over one or more selected objects of the plurality of candidate objects, deselecting the one or more selected objects, or
a combination thereof.

In some embodiments, said processing the image based on the identified plurality of objects further comprises: selecting one or more of the plurality of objects in response to an input; and generating one or more action suggestions for the selected one or more of the plurality of objects.

In some embodiments, said generating one or more action suggestions comprises: obtaining one or more image-related features using one or more first artificial intelligence (AI) models based on the image, a segmentation map of the segmented image, and the one or more selected objects; obtaining one or more caption-related features using one or more second AI models based on the image, the segmentation map of the segmented image, and the one or more selected objects; and generating one or more predicted actions as the one or more action suggestions using one or more third AI models based on the one or more image-related features and the one or more caption-related features.

In some embodiments, the one or more first AI models comprise a Contrastive Language-Image Pretraining (CLIP) image encoder.

In some embodiments, said obtaining the one or more caption-related features comprises: obtaining the one or more caption-related features using one or more second AI models based on the image, the segmentation map of the segmented image, the one or more selected objects, and one or more captions of the image.

In some embodiments, the one or more second AI models comprise an image caption model.

In some embodiments, the one or more caption-related features comprise a caption of the image and a caption of the one or more selected objects.

In some embodiments, the one or more third AI models comprise a transformer decoder.

In some embodiments, the one or more image-related features are in a form of an image embedding vector.

In some embodiments, said generating one or more action suggestions comprises: generating a one-dimensional (1D) vector using one or more fourth AI models based on the one or more caption-related features, and fusing the image embedding vector and the 1D vector into a fused vector; and said generating the one or more predicted actions comprises: generating the one or more predicted actions as the one or more action suggestions using one or more third AI models based on the fused vector.

In some embodiments, said processing the image based on the identified plurality of objects further comprises: receiving a first input indicating a pointer holding on one of the plurality of objects; and starting to receive one or more voice commands.

According to one aspect of this disclosure, there is provided one or more processors functionally connected to the one or more non-transitory, computer-readable storage media, wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided one or more non-transitory, computer-readable storage media comprising computer-executable instructions, wherein the instructions, when executed, cause one or more processors to perform any of the above-described methods and/or any of the methods disclosed herein.

According to one aspect of this disclosure, there is provided a system comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided an apparatus comprising one or more processors functionally connected to one or more memories storing instructions; the one or more processors are configured to execute the instructions to perform any of the above-described methods and/or any of the methods disclosed herein.

According to one aspect of this disclosure, there is provided one or more memories storing instructions; the instructions, when executed, cause one or more processors to perform any of the above-described methods and/or any of the methods disclosed herein.

In another aspect, embodiments of this disclosure provide an apparatus, wherein the apparatus comprises a function or unit to perform any of the above-described methods and/or any of the methods disclosed herein.

In another aspect, embodiments of this disclosure provide a computer readable storage medium, comprising one or more instructions, wherein when the one or more instructions are run on a computer, the computer performs any of the above-described methods and/or any of the methods disclosed herein.

In another aspect, embodiments of this disclosure provide a non-transitory computer-readable medium storing instruction the instructions causing a processor in a device to implement any of the above-described methods and/or any of the methods disclosed herein.

In another aspect, embodiments of this disclosure provide a device configured to perform any of the above-described methods and/or any of the methods disclosed herein.

In another aspect, embodiments of this disclosure provide a processor, configured to execute instructions to cause a device to perform any of the above-described methods and/or any of the methods disclosed herein.

In another aspect, embodiments of this disclosure provide an integrated circuit configure to perform any of the above-described methods and/or any of the methods disclosed herein.

According to one aspect of this disclosure, there is provided a module comprising: one or more circuits for performing any of the above-described methods and/or any of the methods disclosed herein.

According to one aspect of this disclosure, there is provided one or more processors functionally connected to one or more memories for performing any of the above-described methods and/or any of the methods disclosed herein.

According to one aspect of this disclosure, there is provided an apparatus comprising: one or more processors functionally connected to one or more memories for performing any of the above-described methods and/or any of the methods disclosed herein.

According to one aspect of this disclosure, there is provided an apparatus configured to perform any of the above-described methods and/or any of the methods disclosed herein.

In some embodiments the apparatus comprises one or more units configured to perform any of the above-described methods and/or any of the methods disclosed herein.

According to one aspect of this disclosure, there is provided one or more non-transitory, computer-readable storage media comprising computer-executable instructions, wherein the instructions, when executed, cause at least one processing unit, at least one processor, or at least one circuits to perform any of the above-described methods and/or any of the methods disclosed herein.

According to one aspect of this disclosure, there is provided one or more computer-readable storage media storing a computer program, wherein, when the computer program is executed by an apparatus, the apparatus is enabled to implement any of the above-described methods and/or any of the methods disclosed herein.

According to one aspect of this disclosure, there is provided a computer program product including one or more instructions, wherein, when the instructions are executed by an apparatus, the apparatus is enabled to implement any of the above-described methods and/or any of the methods disclosed herein.

According to one aspect of this disclosure, there is provided a computer program, wherein, when the computer program is executed by a computer, an apparatus is enabled to implement any of the above-described methods and/or any of the methods disclosed herein.

According to one aspect of this disclosure, there is provided a system comprising a node for performing any of the above-described methods and/or any of the methods disclosed herein.

According to one aspect of this disclosure, there is provided an apparatus for implementing any of the above-described methods and/or any of the methods disclosed herein in any possible implementation of the foregoing aspects.

In various embodiments, the above-described methods and/or the methods disclosed herein provide various benefits.

For example, in some embodiments, the user-intention based semantic-region selection allows inferring selected regions in different granularity levels based on touch interactions.

In some embodiments, pointer hovering provides straightforward preview of possible selection of the objects or regions that the pointer is hovering thereon.

In some embodiments, controlling the semantic similarity allows flexible multiple objects selection with user adjustable semantic similarity.

In some embodiments, using gestures and UIs to select similar semantic objects and/or scenes significantly simplifies user operations.

In some embodiments, generating action suggestions based on changes of the selected region may greatly facilitate user operations.

In some embodiments, voice commands provide further options and flexibilities for user operation.

### BRIEF DESCRIPTION OF THE DRAWINGS

For a more complete understanding of the disclosure, reference is made to the following description and accompanying drawings, in which:

FIG. 1 is a schematic diagram of a computer system, according to some embodiments of this disclosure;

FIG. 2 is a schematic diagram showing a simplified hardware structure of a computing device of the computer system shown in FIG. 1;

FIG. 3 is a schematic diagram showing a simplified software architecture of a computing device of the computer system shown in FIG. 1;

FIG. 4 is a schematic diagram showing an artificial intelligence (AI) engine, wherein the AI engine comprises a large language model (LLM);

FIG. 5 is a flowchart showing a smart selection procedure performed by the computer system shown in FIG. 1 for multimodal interaction, according to some embodiments of this disclosure;

FIGS. 6A to 6C show an example of segmenting an image 300 to semantic objects in various levels of granularity, according to some embodiments of this disclosure;

FIG. 7 is a flowchart showing an example of semantic object selection used the smart selection procedure shown in FIG. 5, according to some embodiments of this disclosure;

FIG. 8 is a flowchart showing an example of hovering for previewing semantic object selection used the smart selection procedure shown in FIG. 5, according to some embodiments of this disclosure;

FIGS. 9A and 9B show an example of controlling the number of selected objects based on object similarity, according to some embodiments of this disclosure;

FIGS. 10A and 10B show another example of controlling the number of selected objects based on object similarity, according to some embodiments of this disclosure;

FIGS. 11A and 11B show an example of using gestures to select semantic objects, according to some embodiments of this disclosure;

FIGS. 12A and 12B show an example of using gestures to inverse semantic object selection, according to some embodiments of this disclosure;

FIGS. 13A to 13C show an example of using gestures to deselect a semantic object, according to some embodiments of this disclosure;

FIGS. 13D to 13F show an example of using gestures to deselect one or more semantic objects, according to some embodiments of this disclosure;

FIGS. 14A to 14D show an example of using gestures to deselect multiple semantic objects, according to some embodiments of this disclosure;

FIGS. 15A to 15D show an example of using a user interface (UI) component to select semantic objects, according to some embodiments of this disclosure;

FIGS. 16A and 16B show an example of using a UI component to inverse semantic object selection, according to some embodiments of this disclosure;

FIGS. 17A and 17B show an example of displaying recommendations or suggestions based on object selections, according to some embodiments of this disclosure;

FIG. 18 is a flowchart showing a recommendation-generation method for determining proactive recommendations based on the selected region, according to some embodiments of this disclosure;

FIG. 19 is a flowchart showing a procedure of using voice commands to perform actions on the selected region, according to some embodiments of this disclosure; and

FIG. 20 shows an example of using voice commands to perform actions on the selected region following the procedure shown in FIG. 19.

### DETAILED DESCRIPTION

Embodiments disclosed herein relate to systems and apparatuses using large language models (LLMs). The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

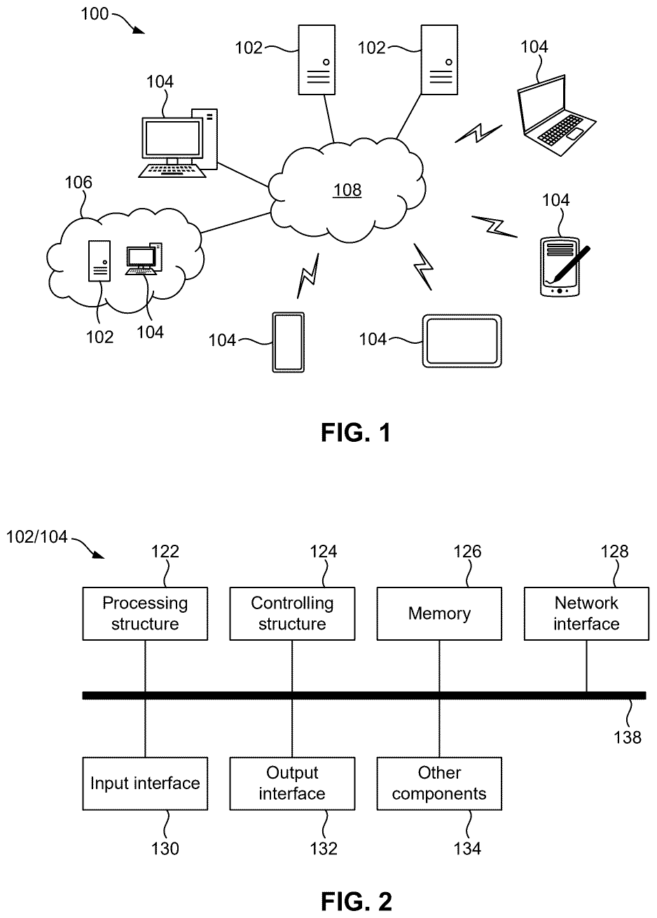

Turning now to FIG. 1, a computer system is shown and is generally identified using reference numeral 100. As shown, the computer system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverses the input (for example, forming a low voltage, a state with no electrical current, a state with no light, or the like), and output the inversed input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

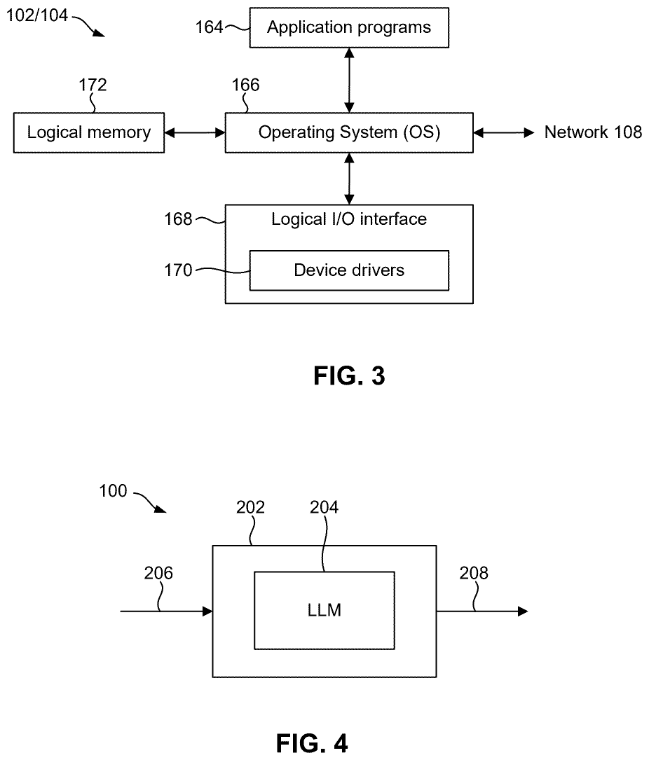

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), HarmonyOS® (HarmonyOS is a registered trademark of HUAWEI TECHNOLOGIES CO., LTD., Shenzhen, China), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer system 100 may have the potential to perform various tasks, it cannot perform any tasks and is of no use without meaningful firmware and/or software. As will be described in more detail later, the computer system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Multimodal Interaction Using Pointer-Based Gesture

The computing devices such as the server computer 102 and/or the client computing device 104 may be used for multimodal interaction such as imaging processing, for example, for region-based image editing with assistance of artificial intelligence (AI).

For example, the academic paper entitled “Gres: Generalized referring expression segmentation”, by Liu, et al. published on Proceedings of the IEEE/CVF conference on computer vision and pattern recognition, 2023, incorporated herein by reference in its entirety, discloses an AI-assisted region-based image editing method that may allow users to describe objects they are trying to select. However, it is difficult for users to communication their desired selection easily and articulately, leading to inaccurate selections retrieved by the model.

In Adobe's Project Stardust, users may utilize their mouse to select objects with two levels of granularity. Their method is designed for personal computer (PC) interaction and always assumes that the user intends to select the largest semantic region under the mouse cursor when the mouse-click occurs, and then breaks the selected semantic region to a second level when the user clicks on the region again. In contrary and as will be described in more detail later, the method disclosed herein automatically infers the user-intended regions based on one or more factors such as the zooming level, touch precision, touch position, selection history, contextual interaction, and/or the like.

Some mobile photo-editing applications, such as the Samsung gallery app, use tap to extract the main objects of an image. This approach does not consider varying levels of granularity. Other applications, such as the Apple and Google Pixel gallery app, use circle or brush to select areas. The interaction is less accurate and more complex, and the user is unable to preview their selected region.

The existing AI-assisted region-based image editing method solutions applicable towards touch devices usually do not allow for different levels of granularity and multi-selection. Action recommendations are not generated proactively depending on the selected region, and in some cases, there is no preview of what the user is selecting prior to the selection gesture, leading to a repetitive and time-consuming editing workflow.

In the following, various embodiments of AI-assisted multimodal interaction methods using pen-based gestures are disclosed. The AI-assisted multimodal interaction methods disclosed herein leverage the semantic relationships between objects and user intents for improving region-based user selection, thereby achieving some or all of the following:
usable on capacitive touch devices (such as smartphone and tablets);
allowing multi-target object selection;
allowing selecting varying levels of object granularity; and
providing action suggestions.

For example, in various embodiments, the AI-assisted multimodal interaction methods disclosed herein may determine user intention when a selection is triggered, and provide selection preview on hover to provide users with more control over their initial selection. The AI-assisted multimodal interaction methods disclosed herein may determine similarity between objects to allow users to control their amount of multiple selection using gestures and/or user interface (UI). The AI-assisted multimodal interaction methods disclosed herein may allow users to trigger smart action suggestions based on the selected region. The AI-assisted multimodal interaction methods disclosed herein may identify when to activate and extract voice commands applied to the final selection.

In some embodiments, the AI-assisted multimodal interaction methods disclosed herein may be implemented on a client computing device 104, for example, as one or more application programs, wherein, depending on the specific implementation, the client computing device 104 comprises suitable sensors, computing units, input/output units, and/or the like, for example, one or more CPUs, storage disks, memories, BLUETOOTH® components, WI-FI® components, IMU sensors, pressure sensors on a touchscreen or on the edge thereof, microphones, cameras, compacity-enable area (for touch-related interaction), displays, vibration actuators, speakers, lights, buttons, and/or the like.

Herein, a user input such as a point-touch input, a pointer-hovering input, a voice input, or the like may be generally denoted an input event, and may be simply called a “user input” or “input” (that is, without the word “event”) for ease of description. A pointer is a tool (such as a finger, a stylus, a pen, or the like) for interacting with a touch-sensitive surface (or simply called a “touch surface”) to cause one or more touch-related signals. Example of the interactions between the pointer and the touch surface may be the pointer touching on the touch surface (and maybe with differentiable pressures), the pointer dragging or moving on the touch surface, the pointer hovering above the touch surface, and/or the like.

In some embodiments, the client computing device 104 has the access to and with the collaboration of one or more suitable AI tools running on the server computer 102 (that is, on the cloud), such as but not limited to one or more foundation models (FMs, such as one or more large language models (LLMs)), automatic speech recognition (ASR) services, optical character recognition (OCR) services, AI assistants or agents, and/or the like.

In some embodiments, some of the one or more AI tools may run on the cloud and others of the one or more AI tools may run on the client computing device 104 (that is, locally).

In some embodiments, the one or more AI tools may run on the client computing device 104. In these embodiments, the system 100 may only comprise the client computing device 104 (that is, the system 100 in these embodiments is reduced to a single computing device 104).

For example, in some embodiments, the computer system 100 executes an artificial intelligence (AI) engine (for example, in the form of one or more software programs running on a server computer 102 and/or a client computing device 104). As shown in FIG. 4, the AI engine 202 comprises a FM 204 such as a LLM for processing input 206 (also called “prompt”; for example, natural language input in the form of text, voice, images, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub) words into vector representations.

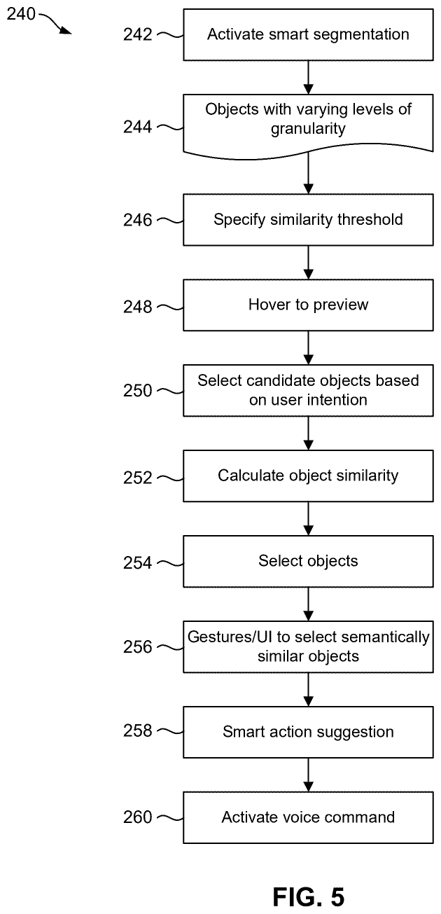

FIG. 5 is a flowchart showing an example of a smart selection procedure 240 for multimodal interaction, according to some embodiments of this disclosure.

The procedure 240 starts after an image is received. At step 242, smart segmentation is activated, wherein the AI engine 202 is used to identify, from the received image, all objects 244 (also called “semantic objects”) in the image at a plurality of granularity levels. Herein, the term “semantic objects” refers to distinct, recognizable objects within an image, such as a person, a dog, a tree, and/or the like.

More specifically, the AI engine 202 iteratively identifies, from the image (which may be identified as an object at the first granularity level (denoted a “level-1 object”) or each object at a certain granularity level, one or more semantic objects at the next granularity level.

For example, the AI engine 202 may identify the image as the level-1 object and then process it to identify details or distinct areas (such the head of the person or the trunk of tree) therewithin as semantic objects at the second granularity level (that is, level-2 objects, which are at a higher granularity level compared to the level-1 object). This processing may be iteratively or repeatedly performed to identify further details or distinct areas (such as the eyes, nose and mouth on the head of the person) within each lower-level object, wherein such recognized details or distinct areas may be identified as objects at the next granularity level, thereby obtaining a plurality of objects at a plurality of granularity levels, wherein an object at a higher granularity level constitutes a detail of an object at a lower granularity level. Herein, the degree of details that an object has been dissected into is denoted the object's granularity level or level of granularity.

At step 246, the user may specify a similarity threshold to be used for object selection, and control the amount of multiple selection based on similarity.

At step 248, the user may hover a pointer over an object or a region of the image. In response, the preview of possible selection of the object or region of the image is shown, for example, by highlighting the area that may be selected (for example, overlaying a predefined color on the object or the region of the image, highlighting the edge of the object or the region of the image, and/or the like).

At step 250, the user may perform a gesture (described in more details later) to select one or more objects. In response, the system 100 determines the user's intention (described in more details later) and selects one or more candidate objects based on the determined user's intention.

At step 252, the object similarities (that is, the similarities between different candidate objects) are calculated, which may be used for similarity-based multiple-object selection. In some embodiments, the similarity refers to semantic similarity. For example, candidate objects of same semantic types (such as humans, animals, dogs, or the like may have the highest similarity, candidate objects of similar semantic types (such as different plants, different pets, or the like) may have a high similarity, and candidate objects of different semantic types (such as human and animal, animal and plant, or the like) may have a low similarity.

At step 252, the object similarities may be calculated in any suitable manner. For example, the object similarities may be calculated as the similarities between the candidate objects and a reference object (such as the first candidate object determined based on the user's intention, a user-designated candidate object, or the like).

At step 254, one or more candidate objects are selected based on the calculated similarities and the similarity threshold. For example, when an object-selection gesture may traverse a plurality of candidate objects, only those candidate objects with similarities greater than the similarity threshold are selected.

At step 254, the selection may be automatically made after the user's object-selection gesture is completed. Alternatively, the use may confirm the object selection using a suitable method such as pressing the pointer on the highlighted area, using a voice command, and/or the like.

At step 256, the user may perform one or more gestures or use the pointer to operate on the UI (such as the touch surface) to adjust the object selection such as further selecting one or more semantic objects, deselecting one or more semantic objects, inversing the selection, or the like. In some embodiments, inversing the selection means selecting all previously unselected objects and deselecting all previous selected objects. In some other embodiments, inversing the selection means selecting all except the previously unselected objects (that is, selecting all previously unselected objects and parts of the image that are not objects) and deselecting all previous selected objects. In some embodiments, the user may also or alternatively perform other methods, for example, the conventional selection method of pressing the SHIFT or CTRL key on a keyboard to adjust the object selection.

Based on the selection, suggested action recommendations may be shown on the UI (step 258). The user may use voice command to modify the selected region, or press the pointer on the displayed recommendations to modify the selected region (step 260).

Those skilled in the art will appreciate that the flowchart shown in FIG. 5 is only an example for illustrative purposes, and variations thereto are readily available. For example, in various embodiments, some steps of the procedure 240 may be performed in parallel or in a different order, some steps may be omitted, and/or other suitable steps may be included.

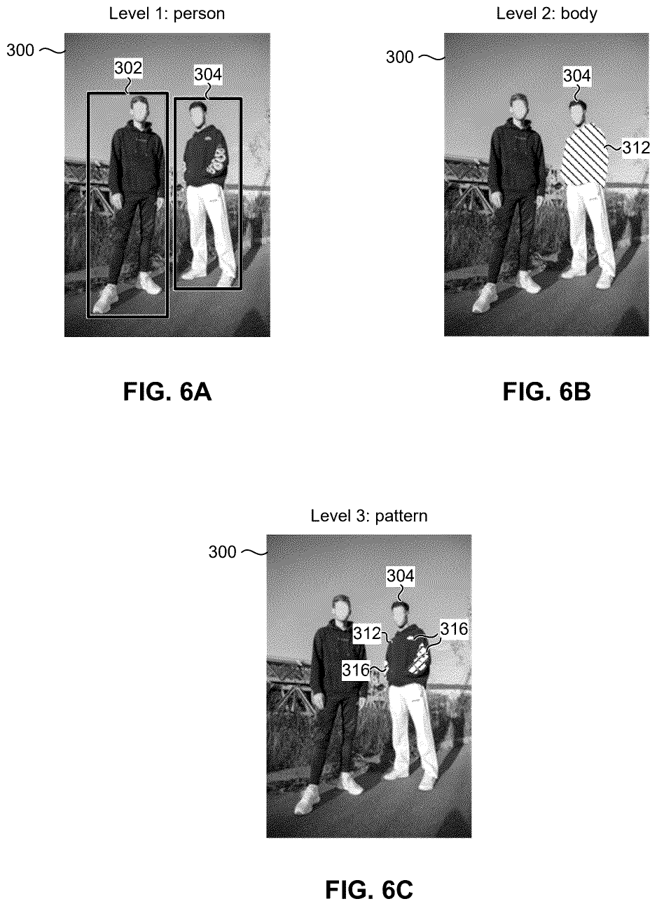

FIGS. 6A to 6C show an example of segmenting an image 300 to semantic objects in various levels of granularity. In this example, the image 300 is identified as the level-1 semantic object.

As shown in FIG. 6A, after the image 300 is received, the system 100 uses the AI engine 202 to segment the image 300 and identify two semantic objects 302 and 304 as the level-2 objects. Those skilled in the art will appreciate that any suitable AI-based image segmentation methods may be used, such as those described in academic paper entitled “Recent progress in semantic image segmentation,” by Liu, et al., published in Artificial Intelligence Review (2019) 52:1089-1106, the content of which is incorporated herein by reference in its entirety.

The identified objects may be further segmented to identify fine details or regions therein. For example, as shown in FIG. 6B, the identified object 304 is further segmented to identify the region of the upper body 312 therein as a level-3 object. Other fine details such as head, arms, legs, feet, and/or the like may also be identified as objects at respective granularity levels.

The identified fine details may be further segmented to identify finer details or regions therein as objects at respective granularity levels. For example, as shown in FIG. 6C, the identified upper body 312 is further segmented to identify the patterns 316 therein. Other finer details such as eyes, nose, mouth, ears in the head may also be identified.

Therefore, the segmentation and object identification may be repeatedly performed to identify objects at various granularity levels (that is,), thereby obtaining objects at different levels of granularity, wherein an identified object may comprise one or more other objects at a lower granularity level. For example, as shown in FIGS. 6A to 6C, the level-1 object (that is, the image 300) comprises two level-2 objects 302 and 304 (which are humans; of course, other level-1 objects may also be identified). The object 304 comprises a level-3 object 312 (which is the upper body of the person 304). The object 312 comprises three level-4 objects 316 (which are the patterns).

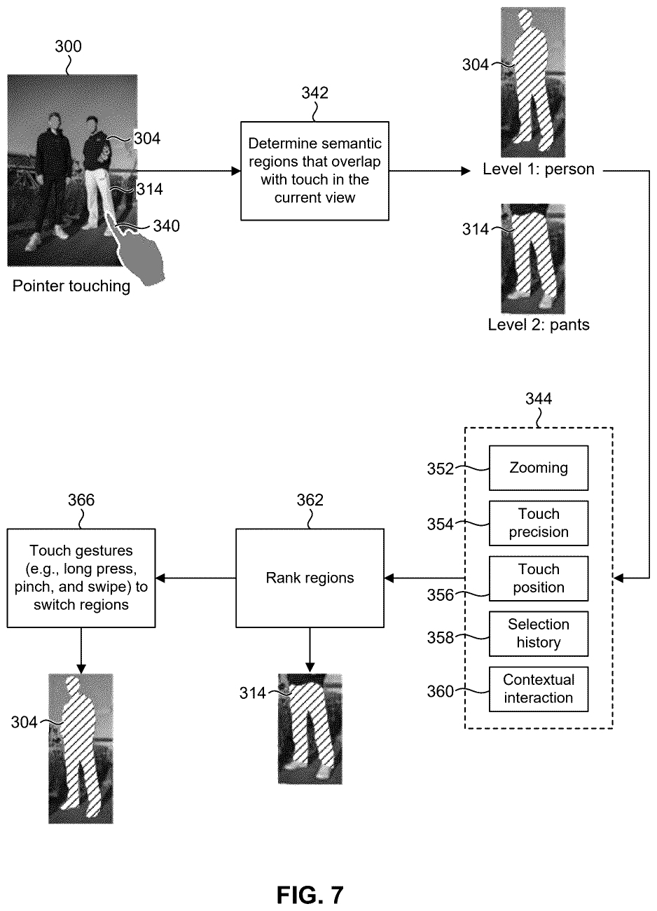

FIG. 7 shows an example of semantic object selection. As shown, when the user touches the pointer 340 on the image 300 to trigger a selection, the system 100 determines the semantic region in the current view that overlaps with the pointer touch (step 342).

The touch point (which, more precisely, is a touch area) may overlap with different objects (denoted an “overlapped semantic object” or a an “overlapped semantic region”) at different granularity levels. For example, as shown in FIG. 7, the touch point may overlap with the person 304 and the pants 314 of the person 304. Then, a plurality of features 344 are calculated to determine the granularity level at which the user is intended to select an object. In some embodiments, the features 344 include one or more of the following:
zooming 352: which hints which one of the overlapped semantic objects the user intends to select. In other words, a higher zooming level or setting may hint that the user intends to select finer details or regions. For example, if the image is in a higher zooming level or setting, the user more likely intends to select an object of a higher granularity level (that is, more likely intending to select the detailed feature) than an object of a lower granularity level. On the other hand, if the image is in a lower zooming setting, the user more likely intends to touch an object of a lower granularity level than an object of a higher granularity level.
touch precision 354: which is the intersection of the pointer-touch area and an overlapped semantic object, divided by the pointer-touch area. As those skilled in the art will appreciate, a pointer contacting the touch surface gives rise to a pointer-touch area of a certain size (instead of a size-less point) on the touch surface. When a user touches a pointer on a semantic object, the pointer-touch area caused by the pointer may or may not fully fall within the area of the semantic object. Thus, the intersection of the pointer-touch area and the area of the semantic object indicates the pointer's touch precision. In other words, a larger intersection of the pointer-touch area and the area of the semantic object indicates a more precise touch on the semantic object (which reaches a maximum when the pointer-touch area fully fall within the area of the semantic object). On the other hand, a smaller intersection of the pointer-touch area and the area of the semantic object indicates a less precise touch on the semantic object (which reaches a minimum when the pointer-touch area is fully outside of the area of the semantic object). As the size of the pointer-touch area may vary depending on the manner of pointer touch (for example, the angle of the pointer when contacting the touch surface, the pressure that the pointer applies to the touch surface, and/or the like), dividing the intersection of the pointer-touch area and an overlapped semantic object by the pointer-touch area provide a normalization for a fair comparison.
touch position 356: which is the relative distance between the center of the pointer-touch area and the center of an overlapped semantic object;
selection history: which includes the previous touches and their corresponding object selections, which may provide personalized region suggestion; and
contextual interaction such as a list of already selected objects: meaning that, if the user has selected an object at a certain granularity level, the next selection may be an object in the same granularity level.

Based on the calculated features 344, the overlapped semantic objects (such as the level-1 object 304 and the level-2 object 314) are ranked (step 362), and the semantic object (for example, the pants 314) with the highest rank becomes the selected region or object.

The user may use touch gestures (such as long press, pinch, swipe, and/or the like) to switch the selection between the overlapped semantic objects (step 366), for example, switching the selection from the pants 314 to the person 304.

In this way, the system 100 first identifies all overlapped semantic objects at various levels of granularity, and then determines the semantic object that the user intended to select based on semantic region selection.

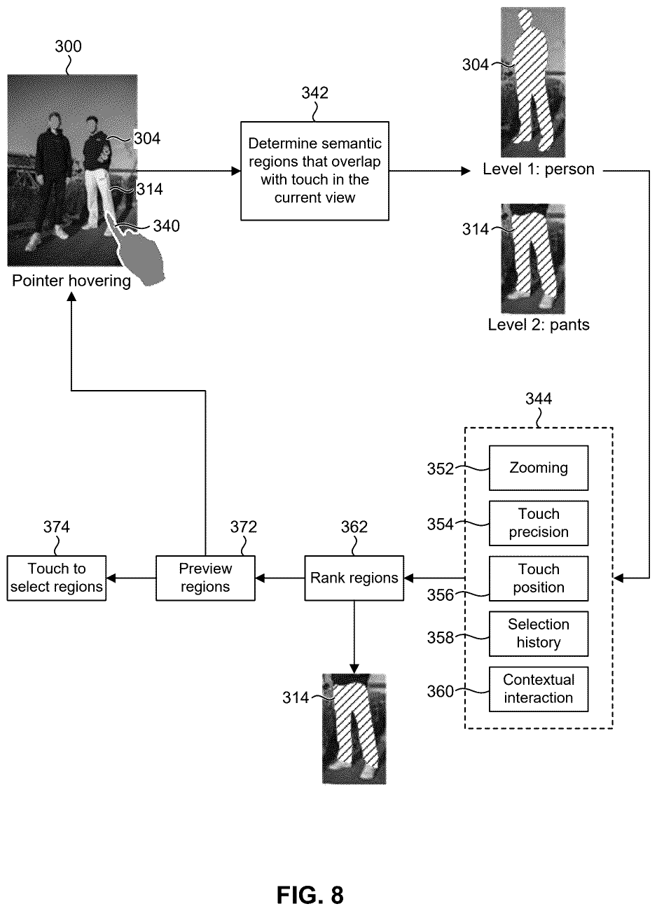

FIG. 8 shows an example of hovering for preview. As shown, the user may hover the pointer 340 in proximity with the displayed image 300. The system 100 determines the semantic region in the current view that overlaps with the pointer touch (step 342).

Then, the system 100 calculates a plurality of features 344, as described above, to determine the granularity level, and accordingly, which region to be selected.

Based on the calculated features 344, the overlapped semantic objects are ranked (step 362), and the semantic object (for example, the pants 314) with the highest rank becomes the candidate region or object for selection. A preview of the candidate region 314 is then shown (step 372), for example, by highlighting the candidate region. The user may touch the candidate region 314 to make the semantic object selection (step 374), or may continue to hover the pointer over the same or another semantic object for preview.

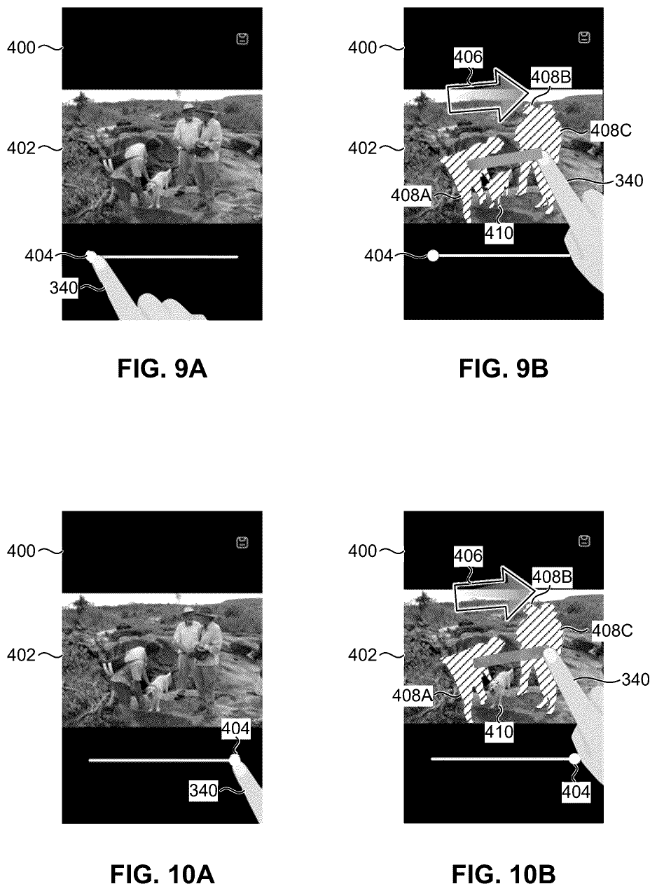

As an image may contain many objects, a user may only want to select semantically similar objects when performing multiple-object selection. FIGS. 9A and 9B show an example of controlling the number of selected objects based on object similarity.

As described above, after the smart segmentation is activated and the objects in the image are identified with various granularity levels, the similarities between different objects are then calculated. In some embodiments, the object similarity may be a value within the range of [0, 1] (that is, between zero to one, including zero (0) and one (1)), and may be calculated based on one or more of the following:
object label: for example, “person”, “dog”, “cat”, “tree”, or the like;
spatial relationship: such as foreground and background (that is, a semantic object in the foreground and another semantic object in the background belong to different categories; objects in the foreground (that is, salient objects) may be more semantically similar to each other compared to background and foreground objects); and
visual features.

The user may control the semantic-similarity threshold to select semantic similar objects. For example, as shown in FIG. 9A, a UI 400 displays an image 402 and a slider 404 which may be used for adjusting the semantic-similarity threshold. In FIG. 9A, the user uses the pointer 340 to move the slider 404 to its leftmost position, corresponding to the lowest semantic-similarity threshold (such as zero (0)).

As shown in FIG. 9B, the user then slides the pointer 340 (indicated by the arrow 406) from the person 408A and over a plurality of semantic objects, including the dog 410 and the two people 408B and 408C. The system 100 compares the similarity between each object 410, 408B, 408C and the starting object 408A. As the semantic-similarity threshold is set to the lowest value, all sliding-over objects 408A to 408C and 410 along the pointer sliding trace are then selected.

In another example, the user uses the pointer 340 to move the slider 404 to the rightmost position, thereby adjusting the semantic-similarity threshold to the highest value (such as one (1)) (FIG. 10A).

As shown in FIG. 10B, the user then slides the pointer 340 (indicated by the arrow 406) over a plurality of semantic objects starting from the person 408A, and over the dog 410 and the two people 408B and 40C. The system 100 compares the similarity between each object 410, 408B, 408C and the starting object 408A. As the semantic-similarity threshold is set to the highest value, the selection starts from the first semantic object that the pointer 340 has touched, and only selects the semantic objects with the highest similarity. Consequently, the three people 408 and 410 are selected while the dog 410, which is in a different category than the people 408 and is completely dissimilar to the people 408, is not selected.

In some embodiments, methods, such as gestures, may be used for selecting semantic objects.

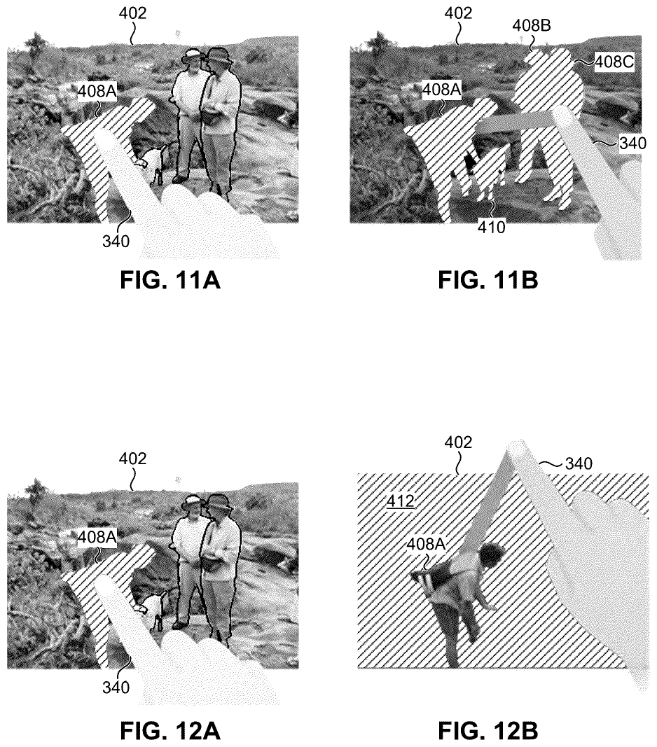

For example, as shown in FIG. 11A, the user may use a pointer 340 to press or touch the image 402 to select the first semantic object such as the person 408A.

As shown in FIG. 11B, then, the user may perform a gesture such as sliding the pointer 340 over one or more other objects (for example, the other two people 408B and 408C and the dog 410) to further select, among these sliding-over objects, one or more semantic objects having the same level of granularity and having similarity values greater than the semantic-similarity threshold.

As another example and as shown in FIG. 12A, the user may use a pointer 340 to select a sematic object such as the person 408 in the image 402.

As shown in FIG. 12B, the user may then perform a gesture such as sliding the pointer 340 out of the image 402 to inverse the selection, that is, deselecting all previously selected semantic objects (such as the semantic object 408A), and selecting all previously unselected semantic objects or the entire scene 412 except the previously selected semantic object 408A.

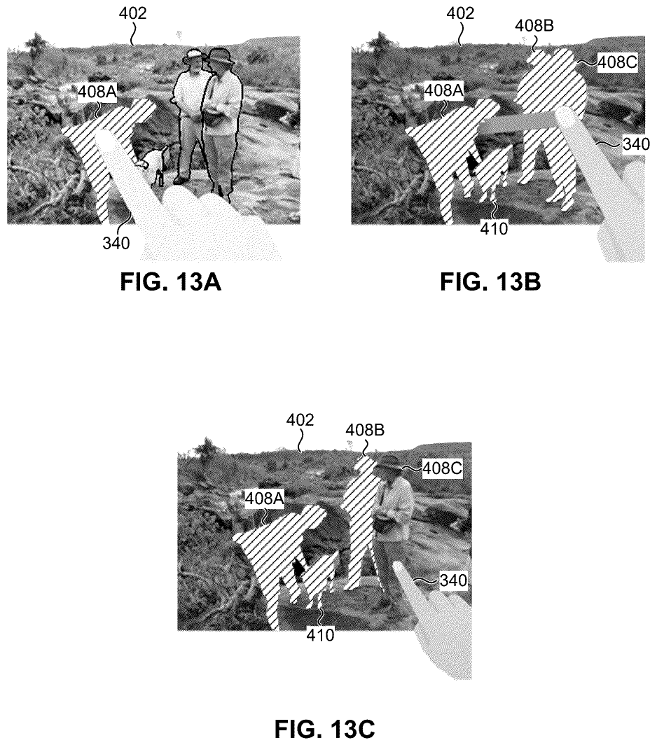

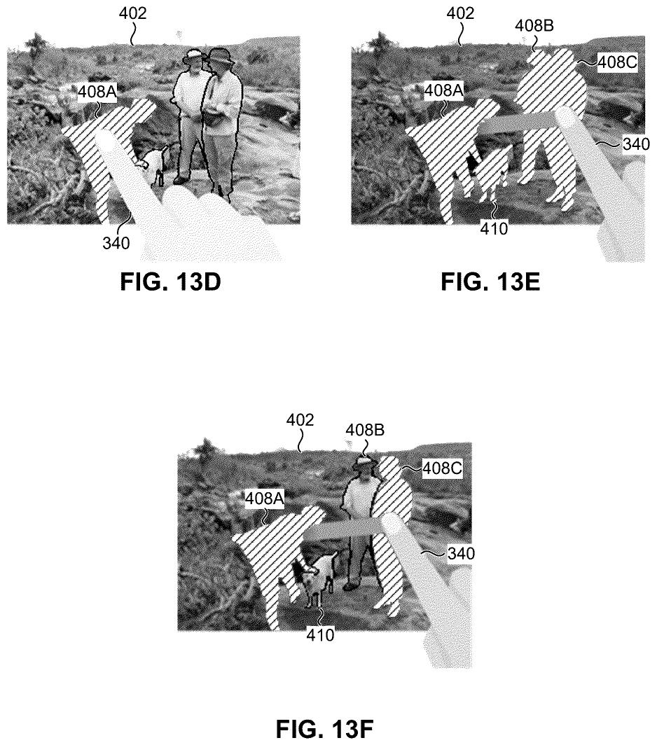

FIGS. 13A to 13C show another example.

As shown in FIG. 13A, the user may use a pointer 340 to press or touch the image 402 to select the first semantic object such as the person 408A.

As shown in FIG. 13B, then, the user may perform a gesture such as sliding the pointer 340 over one or more other objects (for example, the other two people 408B and 408C and the dog 410) to further select, among these sliding-over objects, one or more semantic objects having the same level of granularity and having similarity values greater than the semantic-similarity threshold.

As shown in FIG. 13C, the user may press and hold the pointer 340 on a selected object such as the person 408C to deselect that object 408C.

FIGS. 13D to 13F show an example of using gestures to deselect one or more semantic objects.

As shown in FIG. 13D, the user may use a pointer 340 to press or touch the image 402 to select the first semantic object such as the person 408A.

As shown in FIG. 13E, then, the user may perform a gesture such as sliding the pointer 340 over one or more other objects (for example, the other two people 408B and 408C and the dog 410) to further select, among these sliding-over objects, one or more semantic objects having the same level of granularity and having similarity values greater than the semantic-similarity threshold.

As shown in FIG. 13F, the user may press and hold the pointer 340 on a selected object such as the person 408C. Then, the objects 410 and 408B between the starting object 408A (that is, the object from which the gesture as shown in FIG. 13E starts) and the ending object 408C (that is, the object at which the gesture as shown in FIG. 13E ends) are deselected.

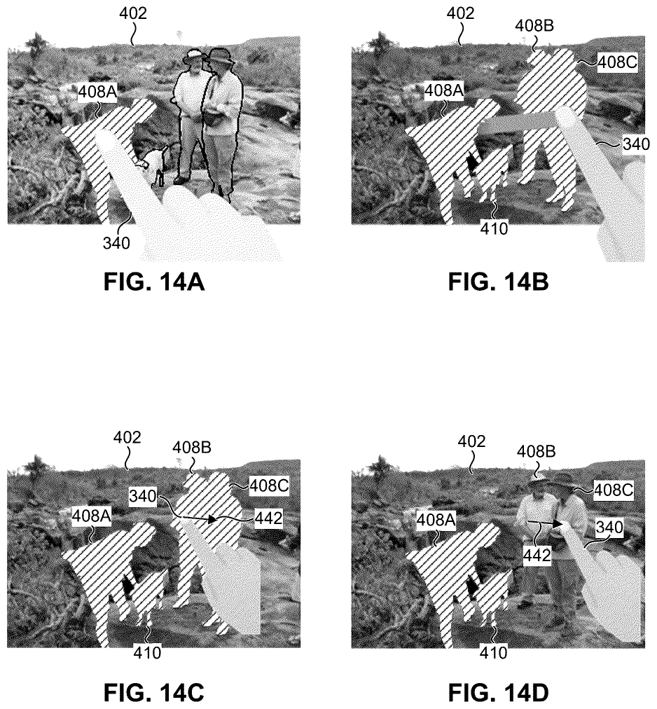

FIGS. 14A to 14D show another example.

As shown in FIG. 14A, the user may use a pointer 340 to press or touch the image 402 to select the first semantic object such as the person 408A.

As shown in FIG. 14B, then, the user may perform a gesture such as sliding the pointer 340 over one or more other objects (for example, the other two people 408B and 408C and the dog 410) to further select, among these sliding-over objects, one or more semantic objects having the same level of granularity and having similarity values greater than the semantic-similarity threshold.

As shown in FIG. 14C, after object selection, the user may slide the pointer 340 from a first one of the selected objects, such as the object 408B, to a second one of the selected objects, such as the object 408C, as indicated by the arrow 442. Then, the objects between the first and second objects 408B and 408C are deselected (see FIG. 14D).

In some embodiments, the system 100 may display a UI component for user to use to select one or more similar semantic objects.

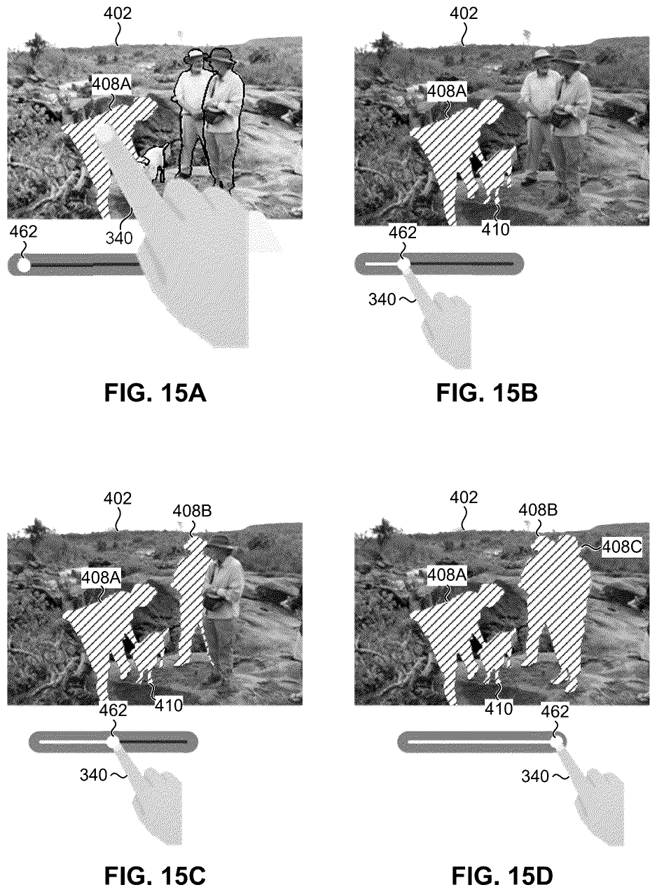

For example, as shown in FIG. 15A, the use may press the pointer 340 on the image 402 to select a first semantic object 408A.

As shown in FIGS. 15B to 15D, a UI component such as a slider 484 is displayed on the screen. The use may use the pointer 340 to slide the slider 642 towards the right-hand side to further select more one or more semantic objects having the same level of granularity and having similarity values greater than the semantic-similarity threshold, such as the dog 410 (FIG. 15B), the person 408B (FIG. 15C), and the person 408C (FIG. 15D). In some embodiments, the selection order is organized by the closeness or distance to the first selected object 408A.

The user may slide the slider 462 towards the left-hand side to deselect one or more selected objects. For example, if the user has selected the three people 408A to 408C and the dog 410 as shown in FIG. 15D, sliding the slider 462 towards the left-hand side may deselect the person 408C (FIG. 15C), the person 408B (FIG. 15B), and the dog 410 (FIG. 15A). In some embodiments, the deselection order is organized by the closeness or distance to the first selected object 408A.

In some embodiments, the system 100 may display a UI component for user to use to inverse the objection selection.

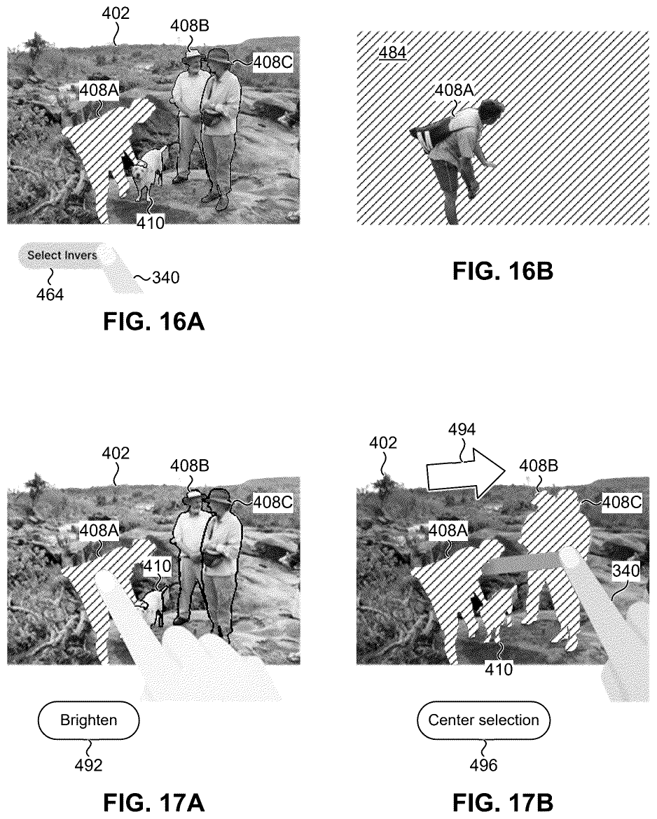

For example, as shown in FIG. 16A, the use may press the pointer 340 on the image 402 to select a semantic object 408A. Then, the user may press the pointer 340 on a UI component such as a button 482 to inverse the objection selection, that is, deselecting the previously selected object 408A, and selecting all previously unselected objects or selecting the entire scene 484 except the previously selected object 408A.

In some embodiments, the system 100 may display recommendations or suggestions based on object selections.

For example, as shown in FIG. 17A, the use may press the pointer 340 on the image 402 to select one semantic object 408A. Accordingly, a suggested action (such as “brighten” for brightening the selected object 408A) may be displayed on the UI in a suitable form such as a button 492. The user may press the pointer 340 on the button 492 to perform the suggested action.

When the user slides the pointer 340 (indicated by the arrow 494) to select multiple objects 408A to 408C and 410, the system may display a suggested action (such as “center selection” for putting the selected objects 408A to 408C and 410 at the center of the image 402) in a suitable form such as a button 496. The user may press the pointer 340 on the button 496 to perform the suggested action.

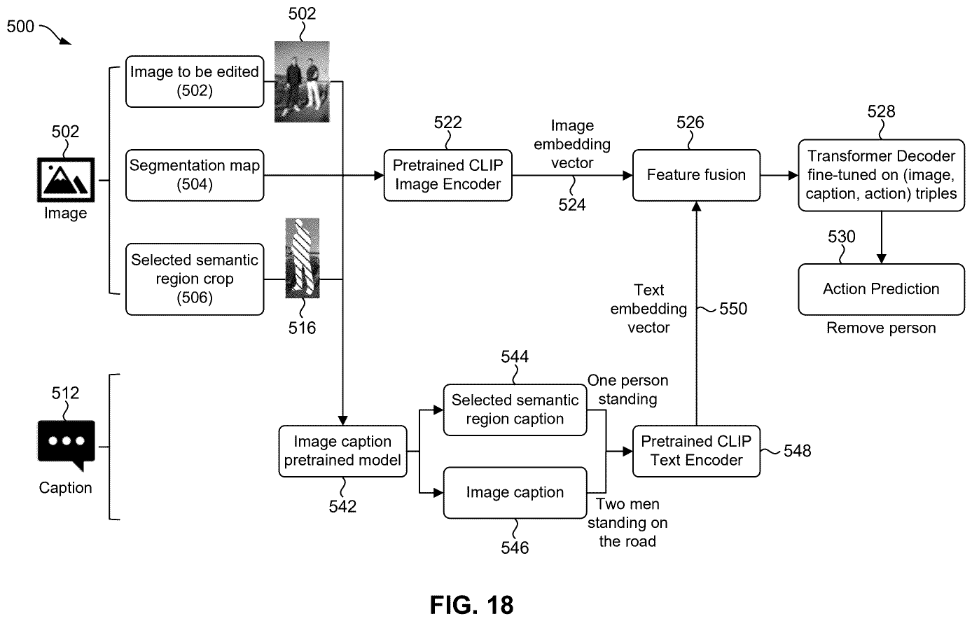

FIG. 18 is a flowchart showing a recommendation-generation method 500 for determining proactive recommendations based on the selected region (which may include one or more selected semantic objects). By using this method, various features may be extracted from the image and related caption using one or more AI models. The features may then be used for training a multimodal large language model for predicting actions.

More specifically, when the selected region in an image 502 is changed, the image 502 and related information 512 (such as one or more captions; if any) are used as input. The image 502, the segmentation map 504 of the image 502 (which indicates how the image 502 is segmented into different semantic objects), and a cropped image of the selected semantic region 506 are sent to one or more first AI models, such as a Contrastive Language-Image Pretraining (CLIP) image encoder 522 to extract various image-related features such as color, object category, and/or the like. The CLIP image encoder 522 (which is part of a neural network trained on a variety of (image, text) pairs) learns image representations that are similar or in the same shared space as the text description of the images.

The extracted features are sent to a feature fusion module 526 as an image embedding vector 524.

The image caption 512, the image 502, the segmentation map 504 of the image 502, and the cropped image of the selected semantic region 506 are sent to one or more second AI models, such as an image caption model 542 to extract or otherwise generate various caption-related features such as the text description or caption 544 of the selected semantic region (for example, “One person standing”), and the text description or caption 546 of the image (for example, “Two men standing on the road”), and/or the like. The extracted caption-related features are sent to one or more third AI models such as a CLIP Text Encoder 548 to extract or otherwise generate a one-dimensional (1D) vector corresponding to text (for example, the captions 544 and 546), which is sent to the feature fusion module 524 as a text embedding vector 550.

The feature fusion module 524 fuses or otherwise combines the received features 526 and 550 into a fused vector, and sends the fused vector to a fourth AI model such as a transformer decoder 528 fine-tuned on (image, caption, action) triples. The transformer decoder 528 then generates predicted actions 530 such as “removing the selected person”.

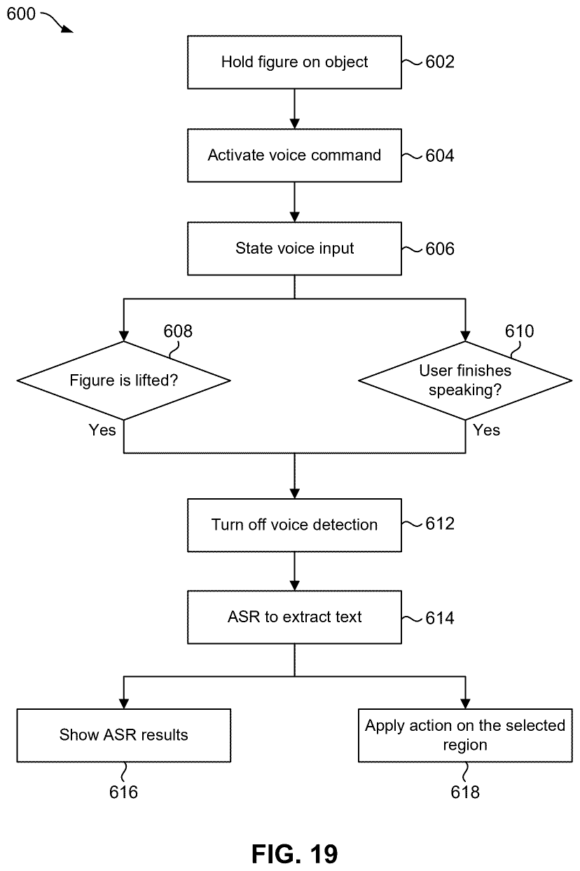

FIG. 19 is a flowchart showing a procedure 600 of using voice commands to perform actions on the selected region.

At step 602, the user holds a pointer on a semantic object to select the semantic object. At step 604, voice command is activated. Then, the user starts to speak the voice command (step 606). The system 100 checks if the pointer is lifted (step 608) or if the voice command is finished (step 610).

If the pointer is lifted or the voice command is finished, the procedure goes to step 612; otherwise, the procedure 600 goes back to step 606 to receive the user's voice (not shown).

At step 612, the system 100 turns off the voice detection. At step 614, the system 100 uses ASR to extract text from the user's voice command, and derive actions from the extracted text. Then, the system 100 displays the extracted text (step 616) and perform the derived actions on the selected region (step 618).

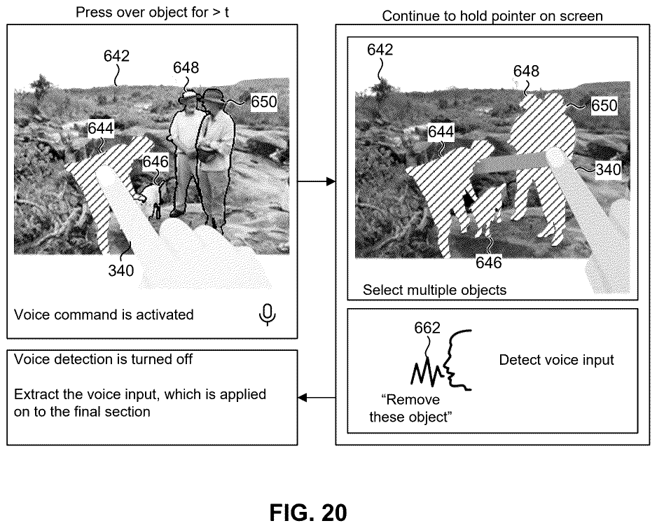

FIG. 20 shows an example. As shown, the user may use a pointer 340 to press and hold on a semantic object 408A in an image 642 for a time period greater than a preconfigured or predetermined time threshold t, to select a semantic object 644 and turn on the voice input. Then, the user may slide the pointer 340 on the image 642 to select multiple semantic objects 644 to 650.

While the pointer 340 is held on the image 642, the user may speak the voice input 662 such as “remove these objects”. The system 100 detects the voice input 662.

After the user finishes speaking or the pointer is lifted from the image 642, the system 100 turns off voice detection, extracts text from the voice input, and applies the actions indicated by the text onto the selected region (the region containing the selected objects 644 to 650).

As those skilled in the art will appreciate, the methods disclosed herein may be used on any suitable devices and systems with touch inputs. In some embodiments wherein the devices and systems support pointer hovering (such as smartphones or tablets having capacitive touch inputs), the hovering-for-preview method disclosed herein may be used.

In various embodiments, the methods disclosed herein may uses gestures to simplify interactions on touch devices and achieve at least some of the following features:
inferring selected regions in different granularity levels based on touch interactions;
pointer-hovering to preview regions that may be selected;
controlling the semantic similarity of objects for multiple objects selection;
gestures and UIs to select multiple similar semantic objects;
providing action suggestions when the selected region is changed; and
activating voice commands when holding the pointer on objects.

In various embodiments, the methods disclosed herein provide various benefits.

For example, in some embodiments, the user-intention based semantic-region selection allows inferring selected regions in different granularity levels based on touch interactions.

In some embodiments, pointer hovering provides straightforward preview of regions that may be selected.

In some embodiments, controlling the semantic similarity allows flexible multiple objects selection with user adjustable semantic similarity.

In some embodiments, using gestures and UIs to select similar semantic objects and/or scenes significantly simplifies user operations.

In some embodiments, generating action suggestions based on changes of the selected region may greatly facilitate user operations.

In some embodiments, voice commands provide further options and flexibilities for user operation.

Although in above embodiments, hovering (which may be considered a non-touch-based gesture) is used for the preview action the preview action objects or regions to be selected), in some embodiments, any suitable touch-based gestures (such as a gesture based on pointer contacting the touch surface) and/or suitable UIs may be used for the preview action.

Although in above examples, the methods disclosed herein are performed by the computer system 100, in some embodiments, no computer system 100 is required, and the methods disclosed herein are performed by a single computing device 102 or 104.

Those skilled in the art will appreciate that the AI models disclosed herein may be trained by any suitable parties, using any suitable training methods, and based on any suitable training data. For example, in some embodiments, one or more of the AI models disclosed herein may be trained by a party different to the users of the methods disclosed herein. In some embodiments, one or more of the AI models disclosed herein may publicly available AI models (such as AI models obtained from some online sources). In some embodiments, one or more of the AI models disclosed herein may trained using general images and related data. In some embodiments, one or more of the AI models disclosed herein may trained using specific images and related data. In some embodiments, one or more of the AI models disclosed herein may trained while the methods disclosed herein are used.

### C. Acronyms, Abbreviations, and Definition of Some Terms

| Full Name | Acronym/Abbreviation/Initialism |
|---|---|
| Large Language Model | LLM |
| Artificial Intelligence | AI |
| Automatic Speech Recognition | ASR |

Herein, the term “semantic objects” refers to distinct, recognizable objects within an image, such as a person, a dog, a tree, and/or the like.

Herein, the term “granularity” refers to the degree of details that the image is dissected into.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method for processing an image, the method comprising:
identifying a plurality of objects of a plurality of granularity levels from the image; and
processing the image based on the identified plurality of objects;
wherein said identifying the plurality of objects comprises:
in a first iteration, using an artificial intelligence (AI) engine to segment the image and identify from the segmented image one or more objects of a first granularity level among the plurality of objects, and
in each of one or more subsequent iterations, using the AI engine to segment each object identified in a previous iteration and identify from the segmented object one or more objects of a next granularity level among the plurality of objects.

2. The computerized method of claim 1, wherein said processing the image based on the identified plurality of objects comprises:
receiving a first input indicating an area of the image;
determining, from the plurality of objects, a plurality of overlapping objects that overlap with the area indicated by the first input;
assessing one or more features to determine a user-intended granularity level from the granularity levels of the plurality of overlapping objects; and
determining one of the plurality of overlapping objects as a selected object.

3. The computerized method of claim 1, wherein said processing the image based on the identified plurality of objects comprises:
receiving a second input; and
determining, from the plurality of objects, a plurality of overlapping objects that overlap with the second input;
assessing one or more features to determine a user-intended granularity level from the granularity levels of the plurality of overlapping objects;
determining one of the plurality of overlapping objects as a candidate object; and
displaying a preview of the candidate object.

4. The computerized method of claim 1, wherein said processing the image based on the identified plurality of objects further comprises:
receiving a first input indicating an area of the image;
determining, from the plurality of objects, a first selected object overlapping with the area indicated by the first input;
receiving a second input;
determining a plurality of candidate objects in response to the second input;
calculating a similarity between each of the plurality of candidate objects and the first selected object, thereby obtaining a plurality of similarities for the plurality of candidate objects; and
marking one or more of the plurality of candidate objects as one or more second selected objects based on similarity comparison of the plurality of similarities and a similarity threshold.

5. The computerized method of claim 1, wherein said processing the image based on the identified plurality of objects further comprises:
receiving a first input; and
selecting, based on the first input, one or more of the plurality of candidate objects, one or more regions of the image, or a combination thereof;
wherein the first input is an indication of manipulation of an object-selection user interface (UI) component or an indication of a pointer touching on the image.

6. One or more processors functionally connected to one or more non-transitory, computer-readable storage media; wherein the one or more non-transitory, computer-readable storage media comprising computer-executable instructions; and
wherein the instructions, when executed, cause the one or more processors to perform the method of claim 1.

7. The one or more processors of claim 6, wherein said processing the image based on the identified plurality of objects comprises:
receiving a first input indicating an area of the image;
determining, from the plurality of objects, a plurality of overlapping objects that overlap with the area indicated by the first input;
assessing one or more features to determine a user-intended granularity level from the granularity levels of the plurality of overlapping objects; and
determining one of the plurality of overlapping objects as a selected object.

8. The one or more processors of claim 6, wherein said processing the image based on the identified plurality of objects comprises:
receiving a second input; and
determining, from the plurality of objects, a plurality of overlapping objects that overlap with the second input;
assessing one or more features to determine a user-intended granularity level from the granularity levels of the plurality of overlapping objects;
determining one of the plurality of overlapping objects as a candidate object; and
displaying a preview of the candidate object.

9. The one or more processors of claim 6, wherein said processing the image based on the identified plurality of objects further comprises:
receiving a first input indicating an area of the image;
determining, from the plurality of objects, a first selected object overlapping with the area indicated by the first input;
receiving a second input;
determining a plurality of candidate objects in response to the second input;
calculating a similarity between each of the plurality of candidate objects and the first selected object, thereby obtaining a plurality of similarities for the plurality of candidate objects; and
marking one or more of the plurality of candidate objects as one or more second selected objects based on similarity comparison of the plurality of similarities and a similarity threshold.

10. The one or more processors of claim 9, wherein said processing the image based on the identified plurality of objects further comprises:
receiving a third input; and
adjusting the similarity threshold in response to the third input.

11. The one or more processors of claim 6, wherein said processing the image based on the identified plurality of objects further comprises:
receiving a first input; and
selecting, based on the first input, one or more of the plurality of candidate objects, one or more regions of the image, or a combination thereof;
wherein the first input is an indication of manipulation of an object-selection user interface (UI) component or an indication of a pointer touching on the image.

12. One or more non-transitory, computer-readable storage media comprising computer-executable instructions, wherein the instructions, when executed, cause one or more processors to perform the method of claim 1.

13. The one or more non-transitory, computer-readable storage media of claim 12, wherein said processing the image based on the identified plurality of objects comprises:
receiving a first input indicating an area of the image;
determining, from the plurality of objects, a plurality of overlapping objects that overlap with the area indicated by the first input;
assessing one or more features to determine a user-intended granularity level from the granularity levels of the plurality of overlapping objects; and
determining one of the plurality of overlapping objects as a selected object.

14. The one or more non-transitory, computer-readable storage media of claim 12, wherein said processing the image based on the identified plurality of objects comprises:
receiving a second input; and
determining, from the plurality of objects, a plurality of overlapping objects that overlap with the second input;
assessing one or more features to determine a user-intended granularity level from the granularity levels of the plurality of overlapping objects;
determining one of the plurality of overlapping objects as a candidate object; and
displaying a preview of the candidate object.

15. The one or more non-transitory, computer-readable storage media of claim 12, wherein said processing the image based on the identified plurality of objects further comprises:
receiving a first input indicating an area of the image;
determining, from the plurality of objects, a first selected object overlapping with the area indicated by the first input;
receiving a second input;
determining a plurality of candidate objects in response to the second input;
calculating a similarity between each of the plurality of candidate objects and the first selected object, thereby obtaining a plurality of similarities for the plurality of candidate objects; and
marking one or more of the plurality of candidate objects as one or more second selected objects based on similarity comparison of the plurality of similarities and a similarity threshold.

16. The one or more non-transitory, computer-readable storage media of claim 15, wherein said processing the image based on the identified plurality of objects further comprises:
receiving a third input; and
adjusting the similarity threshold in response to the third input.

17. The one or more non-transitory, computer-readable storage media of claim 12, wherein said processing the image based on the identified plurality of objects further comprises:
receiving a first input; and
selecting, based on the first input, one or more of the plurality of candidate objects, one or more regions of the image, or a combination thereof;
wherein the first input is an indication of manipulation of an object-selection user interface (UI) component or an indication of a pointer touching on the image.

18. The one or more non-transitory, computer-readable storage media of claim 12, wherein said processing the image based on the identified plurality of objects further comprises:
selecting one or more of the plurality of objects in response to an input; and
generating one or more action suggestions for the selected one or more of the plurality of objects.

19. The one or more non-transitory, computer-readable storage media of claim 18, wherein said generating one or more action suggestions comprises:
obtaining one or more image-related features using one or more first artificial intelligence (AI) models based on the image, a segmentation map of the segmented image, and the one or more selected objects;
obtaining one or more caption-related features using one or more second AI models based on the image, the segmentation map of the segmented image, and the one or more selected objects; and
generating one or more predicted actions as the one or more action suggestions using one or more third AI models based on the one or more image-related features and the one or more caption-related features.

20. The one or more non-transitory, computer-readable storage media of claim 12, wherein said processing the image based on the identified plurality of objects further comprises:
receiving a first input indicating a pointer holding on one of the plurality of objects; and
starting to receive one or more voice commands.
